(19) United States
(12) Patent Application Publication
(10) Pub. No.: US 2025/0199209 A1
(43) Pub. Date: Jun. 19, 2025

(54) USE OF SOLID MATERIALS IN OPTICAL SYSTEMS

(71) Applicant: MOLDNANO (HANGZHOU) TECHNOLOGY CO., LTD., Hangzhou (CN)

(72) Inventors: Kaikai DU, Hangzhou (CN); Lu CAI, Hangzhou (CN); Xing CHEN, Hangzhou (CN)

(73) Assignee: MOLDNANO (HANGZHOU) TECHNOLOGY CO., LTD., Hangzhou (CN)

(21) Appl. No.: 19/071,744

(22) Filed: Mar. 5, 2025

Related U.S. Application Data
(63) Continuation of application No. PCT/CN2024/128108, filed on Oct. 29, 2024.

(30) Foreign Application Priority Data
Nov. 30, 2023 (CN) 202311619421.8

(51) Int. Cl. G02B 3/08; G02B 1/00; G02B 1/02

(52) U.S. Cl. CPC G02B 3/08; G02B 1/002; G02B 1/02; G02B 2207/101

(57) ABSTRACT

Use of a solid material in an optical system is provided. The solid material serves as material of a metasurface focusing lens and includes at least one element from group IIIA, group IVA, group VA, and group IIB of a periodic table. By using the solid material, it can solve a problem of a large volume caused by the externally attached refrigeration structure the existing optical components to eliminate thermal drift, a problem of thermal drift associated with the traditional metalens material that is conducive to miniaturization, and a problem of harsh design and processing conditions of the 4H-SiC metalens material. In addition, it offers advantages of balancing miniaturization and athermalization, lowering manufacturing cost, and being suitable for large scale production applications.

### CROSS-REFERENCE TO RELATED APPLICATIONS

The present application is a Continuation of International Application No. PCT/CN2024/128108, filed on Oct. 29, 2024, which claimed priority to Chinese Patent Application No. 202311619421.8, filed on Nov. 30, 2023, the entire contents of each of which are incorporated herein by reference.

### TECHNICAL FIELD

The present disclosure relates to the technical field of an optical system, and in particular, to use of a solid material in the optical system.

### BACKGROUND

Optical instruments are devices that are capable of generating light waves and displaying images, or receiving light waves and analyzing them to determine their optical properties. These optical instruments include optical measuring instruments, optical testing instruments, microscopic instruments, image software and devices, machine vision devices, multi-media micro interactive, optical tools, metallographic and hardness testers, optical mapping instruments, optical components, fiber optic instruments, optical test instruments, digital optics, light sources and coatings, science optics, laser instruments, photoelectric displays, medical optics, infrared thermography, lenses, or the like. Optical instruments, as a crucial category in the instrumentation industry, are indispensable tools for observation, testing, analysis, control, recording and transmission in various fields such as industrial and agricultural production, resource exploration, space exploration, scientific experimentation, national defense construction, and social life. The volume and weight of the optical system constitute a large proportion of the entire optical instrument, making its miniaturization and athermalization of great significance.

In the optical system, when light beams are reflected and refracted on the surfaces of a variety of optical components such as lenses, mirrors, prisms, and diaphragms, centers of the light beams deviate from their center position due to the non-uniformity of the optical components. In addition, prolonged irradiation of high-power beams causes a large amount of heat accumulation in the focusing objective lens, which can lead to thermal expansion of optical components, resulting in thermal drift in the center positions of the light beams, further leading to thermal aberration and other problems. In order to reduce the adverse effects of thermal drift on optical imaging, measurement and other applications, the following measures are usually taken: (1) selecting appropriate optical materials to avoid the non-uniformity of the optical components having a great impact on the beams; (2) considering the temperature effect of the optical components during the design of the optical system, employing cooling structures such as passive cooling fins, active water cooling heat exchangers, refrigeration Dewars attached to the optical components to reduce temperature to prevent thermal drift; (3) regular calibration and maintenance of the optical system, and timely adjustment or replacement of problematic optical components to ensure the accuracy and stability of the optical system.

CN104535193A discloses an infrared focal plane detector assembly, including: an imaging optical component, a cold screen, and a dewar. The imaging optical component includes a low-temperature filter, an objective lens, and a cold diaphragm integrated inside the dewar; the objective lens including an objective lens 1, an objective lens 2, and an objective lens 3; a window of the dewar employs the objective lens 1 to extend the field of view of the optical system; the low-temperature filter, the objective lens 2, and the objective lens 3 are bonded to the cold screen to ensure their correct optical position and cool the objective lens to a stabilized temperature by conduction of the cold screen. The assembly employs the second measure described above to cool the objective lens etc., keeping them in a constant low temperature environment to avoid the adverse effects of thermal drift; however, this also results in a larger overall volume of the imaging optical components, which is not conducive to the miniaturization of the optical system.

CN114188815B discloses a lensless focusing device for a coherent array laser, including: a coherent array laser, a binary optical microstructure substrate, and a binary optical microstructure. The binary optical microstructure produces a phase modulation effect on the laser beam of each laser unit in the coherent array laser; the structural microelements are all of sub-wavelength thickness; the binary optical microstructure is prepared by etching the binary optical microstructure substrate and then depositing optical materials with dissimilar refractive index; the binary optical microstructure substrate is a SiO₂ substrate, and the binary optical microstructure is a Si₃N₄ layer. The device uses optical materials with dissimilar refractive index to prepare metalens (the binary optical microstructure substrate and the binary optical microstructure) to achieve a lens-free focusing effect, thereby overcoming the miniaturization difficulties existing in the original optical system to some extent. However, due to the low thermal conductivity of conventional superlens materials such as Si, SiO₂, Si₃N₄, etc., there is still a problem of thermal accumulation leading to thermal aberration, which is not conducive to the athermalization of the optical system.

4H-SiC is one of the typical representatives of third-generation semiconductor materials, belonging to wide bandgap semiconductor materials, with a bandgap width of 3.6 ev and a transmittance as high as 95% in the visible light and near-infrared light wavelengths outside of its bandgap. It can be regarded as a wide bandgap lossless medium. CN116736416A discloses a polarization-multiplexing matalens based on 4H-SiC and a method for designing the metalens. The metalens includes a plurality of 4H-SiC sub-wavelength resonance structural units arranged in a two-dimensional array, each of which includes a 4H-SiC substrate and a 4H-SiC nanobrick disposed on the 4H-SiC substrate. The above-described metalens is prepared using the 4H-SiC instead of traditional metalens materials and determining the geometrical parameters of the 4H-SiC sub-wavelength resonance structural unit according to a predetermined design method to enable the focusing efficiency of the focal points in the visible range to reach 75-85%. As compared with visible optical materials, infrared and ultraviolet optical materials have a high refractive index temperature coefficient, making the performance of the optical system more susceptible to temperature variations. Under conventional design concepts, correction and compensation can only be achieved through phase modulation. Additionally, due to the high hardness and brittleness of the 4H-SiC, the processing difficulty increases manufacturing costs, ultimately making it challenging to apply the metalens in the optical system on a large scale.

Therefore, there is an urgent need to provide a material for use in the optical system, which can balance miniaturization and athermalization, reduce manufacturing costs, and be suitable for large scale production applications.

### SUMMARY

One or more embodiments of the present disclosure provide a solid material for a metasurface focusing lens in an optical system, and the solid material includes at least one element from group IIIA, group IVA, group VA, and group IIB of a periodic table.

In some embodiments, the solid material is a silicon carbide material or a diamond material.

In some embodiments, the metasurface focusing lens includes a light-transmitting substrate layer and a metasurface microstructure layer disposed on the light-transmitting substrate layer, and the metasurface microstructure layer is composed of the solid material.

In some embodiments, the metasurface focusing lens includes a light-transmitting substrate layer, a light-transmitting medium layer disposed on the light-transmitting substrate layer, and a metasurface microstructure layer disposed on the light-transmitting medium layer, and the light-transmitting medium layer is composed of the solid material.

In some embodiments, the metasurface focusing lens is composed of the solid material.

In some embodiments, the metasurface microstructure layer includes a plurality of sub-wavelength structure units arranged in a two-dimensional array, and each of the plurality of sub-wavelength structure units includes a plurality of nanopillars arranged in a straight line with a decreasing width.

In some embodiments, in each of the plurality of sub-wavelength structure units, an etching depth d of the nanopillars is within a range of 800-1200 nm, a middle width w of the nanopillars is within a range of 200-450 nm, a period p between two adjacent nanopillars is within a range of 600-800 nm, and a middle width difference Δw between the two adjacent nanopillars is within a range of 30-50 nm.

One or more embodiments of the present disclosure provide a preparation method for a metasurface focusing lens using a solid material, including:
(a) pretreating the solid material by organic cleaning and inorganic cleaning to remove organic matter and inorganic matter remaining on a surface of the solid material;
(b) performing a photolithography treatment on the cleaned solid material obtained in step (a) to realize patterning of a metasurface microstructure region on a surface of a solid material layer;
(c) performing a thin film deposition treatment on the solid material after the photolithography treatment obtained in step (b) to deposit a metal mask on the surface of the solid material layer;
(d) performing metal lift-off on the solid material after the thin film deposition treatment obtained in step (c) to remove the metal mask from a non-metasurface microstructure region;
(e) performing a dry etching (ICP-RIE) treatment on the solid material after the metal lift-off obtained in step (d) to etch the non-metasurface microstructure region of the solid material layer to a predetermined etching depth, and accomplish transferring of patterns of the metasurface microstructure region between the metal mask and the solid material; and
(f) performing a wet etching treatment on the solid material after the dry etching treatment obtained in step (e) to remove the metal mask from the metasurface microstructure region to obtain the metasurface focusing lens.

In some embodiments, the optical system is a microscope optical system, a telescope optical system, a camera optical system, a projection optical system, a laser optical system, a Fourier transform optical system, a scanning optical system, or a fiber optic optical system.

In some embodiments, the optical system is a laser beam expanding optical system, a laser collimation optical system, or a laser focusing optical system.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram of a structure of the metasurface focusing lens obtained in Embodiment 1 according to some embodiments of the present disclosure;

FIG. 2 is a scanning electron microscope (SEM) image of the metasurface focusing lens obtained in Embodiment 1 with a magnification of 300×, observed at a tilt angle of 45° according to some embodiments of the present disclosure;

FIG. 3 is an SEM image of the metasurface focusing lens obtained in Embodiment 1 with a magnification of 5,000×, observed at a tilt angle of 45° according to some embodiments of the present disclosure;

FIG. 4 is an SEM image of the metasurface focusing lens obtained in Embodiment 1 with a magnification of 15,000×, observed at a tilt angle of 45° according to some embodiments of the present disclosure;

FIG. 5 is an SEM image of the metasurface focusing lens obtained in Embodiment 1 with a magnification of 10,000×, observed vertically according to some embodiments of the present disclosure;

FIG. 6 is an atomic force microscopy (AFM) image of the metasurface focusing lens obtained in Embodiment 1 according to some embodiments of the present disclosure;

FIG. 7 is a diagram of the focal field distribution of the metasurface focusing lens obtained in Embodiment 1 according to some embodiments of the present disclosure; and

FIG. 8 is a focal point test diagram of the metasurface focusing lens obtained in Embodiment 1 according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

As shown in the present disclosure and in the claims, unless the context clearly suggests an exception, the words “a”, “one”, “an” and/or “the” do not refer specifically to the singular but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or apparatus may also include other steps or elements.

Embodiments of the present disclosure provide use of a solid material in an optical system, which solves a problem of large size caused by an externally attached refrigeration structure of an existing optical component to eliminate thermal drift, a problem of thermal drift associated with the conventional metalens material that facilitates miniaturization, and a problem of harsh design and processing conditions of 4H-SiC metalens material, with advantages of balancing miniaturization and athermalization, reducing manufacturing costs, and being suitable for large-scale production applications.

Embodiments of the present disclosure provide a solid material for a metasurface focusing lens in the optical system, and the solid material includes at least one element from group IIIA, group IVA, group VA, and group IIB of a periodic table.

In some embodiments, the solid material is silicon carbide (SiC), silicon germanium (SiGe), germanium (Ge), gallium arsenide (GaAs), gallium nitride (GaN), indium phosphide (InP), indium arsenide antimony (InAlSb), zinc oxide (ZnO), aluminum nitride (AlN), gallium oxide (Ga₂O₃), aluminum oxide (Al₂O₃), gallium phosphide (GaP), indium arsenide (InAs), indium nitride (InN), aluminum arsenide (AlAs), diamond, cubic boron nitride (CBN), magnesium silicate (Mg₂SiO₄), lead titanate (PbTiO₃), barium titanate (BaTiO₃), lithium niobate (LiNbO₃), Al₂O₃CrNd glass, cadmium telluride (CdTe), tungsten oxide (WO₃), zinc ferrite (ZnFe₂O), gamma iron oxide (γ-Fe₂O₃), strontium ferrite (SrO·6Fe₂O₃), cadmium sulfide (CdS), calcium polysulfide (Ca₂Sx), vanadium oxide (VO₂), nickel oxide (NiO), lanthanum boride (LaB₆), barium oxide (BaO), lead magnesium niobium (PMN), barium titanate (BaTiO₃), lithium titanate (LiTiO₃), yttrium aluminum garnet (YAG), lithium niobate (LiNbO₃), gallium phosphate (GaPO₄), calcium titanate (CaTiO₃), rare earth ketone acid salt (YBa₂Cu₃O₇), and a combination material of one or more of metallic materials.

In some embodiments, the solid material is a silicon carbide material or a diamond material.

In some embodiments, the solid material is a combination of one or more of 3C-SiC material, 4H-SiC material, 6H-SiC material, and the diamond material.

In some embodiments, the metasurface focusing lens includes a light-transmitting substrate layer and a metasurface microstructure layer disposed on the light-transmitting substrate layer, and the metasurface microstructure layer is composed of the solid material.

In some embodiments, the metasurface focusing lens includes a light-transmitting substrate layer, a light-transmitting medium layer disposed on the light-transmitting substrate layer, and a metasurface microstructure layer disposed on the light-transmitting medium layer, and the light-transmitting medium layer is composed of the solid material.

In some embodiments, the metasurface focusing lens is composed of the solid material. In some embodiments, the metasurface focusing lens is integrally formed from the solid material, which is beneficial to improve the uniformity of the material.

In some embodiments, the metasurface microstructure layer includes a plurality of sub-wavelength structure units arranged in a two-dimensional array, and each of the sub-wavelength structure units includes a plurality of nanopillars arranged in a straight line with a decreasing width. The two-dimensional array arrangement refers to an array arrangement formed by arranging the sub-wavelength structure units along a first direction and along a second direction. The first direction and the second direction are parallel with respect to the surface of the light-transmitting substrate layer and an angle between the first direction and the second direction is within a range of (−90)-90°. Specifically, the angle between the first direction and the second direction may be −90°, −75°, −60°, −45°, −30°, −15°, 0° (the first direction and the second direction coinciding), 15°, 30°, 45°, 60°, 75°, or 90°. In addition, the nanopillars in each of sub-wavelength structure units are arranged along the first direction with a decreasing width, and the nanopillars may be preferably one or more of cylindrical, conical, frustum shaped, prismatic, frustum shaped, and irregular polyhedral shapes.

In some embodiments, in each of the sub-wavelength structure units, an etching depth d of the nanopillars is within a range of 800-1200 nm, a middle width w of the nanopillars is within a range of 200-450 nm, and a period p between two adjacent nanopillars is within a range of 600-800 nm, and a middle width difference Aw between the two adjacent nanopillars is within a range of 30-50 nm.

Some embodiments of the present disclosure further provide a preparation method for the metasurface focusing lens using the solid material, including:
(a) pretreating the solid material by organic cleaning and inorganic cleaning to remove organic matter and inorganic matter remaining on a surface of the solid material;
(b) performing a photolithography treatment on the cleaned solid material obtained in step (a) to realize patterning of a metasurface microstructure region on a surface of a solid material layer;
(c) performing a thin film deposition treatment on the solid material after the photolithography treatment obtained in step (b) to deposit a metal mask on the surface of the solid material layer;
(d) performing metal lift-off on the solid material after the thin film deposition treatment obtained in step (c) to remove the metal mask from a non-metasurface microstructure region;
(e) performing a dry etching (ICP-RIE) treatment on the solid material after the metal stripping treatment obtained in step (d) to etch the non-metasurface microstructure region of the solid material layer to a predetermined etching depth, and accomplish transferring of patterns of the metasurface microstructure region between the metal mask and the solid material; and
(f) performing a wet etching treatment on the solid material after the dry etching treatment obtained in step (e) to remove the metal mask from the metasurface microstructure region to obtain the metasurface focusing lens.

In some embodiments, the preparation method for the metasurface focusing lens using the solid material further includes:
(a) pretreatment: cleaning the solid material by ultrasonic cleaning with acetone, ethanol, and isopropanol in sequence, with an ultrasonic time of 5-15 min and an ultrasonic frequency of 30-50 kHz, and then blow-drying the solid material with nitrogen to remove the organic matter and inorganic matter remaining on the surface of the solid material;
(b) photolithography: placing the cleaned solid material obtained in step (a) in the center of a carrier plate of a homogenizer, and dripping a photoresist (Zep520A, AZ1500, AZ4500, or AZ6100) for homogenization, with a dripping amount of 1-6 mL, a rotational speed of the homogenization of 2,000-6,000 rpm, and a time of the homogenization of 1-3 min. After the homogenization, placing the solid material on a hot plate at 100-180° C. for 1-3 min, and exposing the solid material using an electron beam lithography (EBL) machine, an ultraviolet lithography machine, or a laser direct writing lithography machine, and then submerging the exposed solid material in 200 mL of a developer solution (Zep-N50) for 50-70 s. Finally, submerging the developed solid material in 200 mL of isopropanol for 25-35 s, and then blow-drying the solid material with nitrogen to realize the patterning of the metasurface microstructure region on the surface of the solid material layer;
(c) thin film deposition: using an electron beam evaporation equipment to uniformly deposit aluminum, silver, gold, and chromium sequentially on the surface of the solid material obtained in step (b) at a deposition rate of 0.01-0.50 nm/s to deposit the metal mask with a thickness of 5-100 nm on the surface of the solid material layer;
(d) metal lift-off: submerging the solid material obtained in step (c) in 200 mL stripping solution (N-methylpyrrolidone) with the metal mask facing upwards, sealing and heating in a water bath for 1-12 h, with a temperature of the water bath of 60-100° C., performing an ultrasonic treatment after the completion of the water bath, with an ultrasonic time of 5-20 min and an ultrasonic frequency of 10-20 kHz. Then using a disposable dropper to bubble in the stripping solution to blow the metal mask fragments suspended in the stripping solution and the metal mask in the non-metasurface microstructure region of the solid material away from the metasurface microstructure region. Then submerging the solid material in 200 mL of isopropanol for 50-70 s, rinsing the solid material with the isopropanol, and blow-drying with nitrogen to remove the metal mask in the non-metasurface microstructure region, and finally placing the stripped solid material into a plasma cleaner, with oxygen as the reaction gas, a gas flow rate of 70-90 sccm, a power of 250-350 W, and a reaction time of 5-20 min, followed by nitrogen purging after removal;
(e) dry etching: using an inductively coupled plasma etching equipment (ICP-RIE) to etch the solid material obtained in step (d), with the etching gas of trifluoromethane at a flow rate of 4-8 sccm, the etching gas of sulfur hexafluoride at a flow rate of 15-20 sccm, and the etching gas of oxygen at a flow rate of 4-8 sccm, an etching power of 400-600 W, an etching rate of 0.1-1 nm/s, and an etching depth of 800-1200 nm, to etch the non-metasurface microstructure region of the solid material layer to a predetermined etching depth, and to accomplish the transferring of patterns of the metasurface microstructure region between the metal mask and the solid material; and
(f) wet etching: submerging the solid material obtained in step (e) in 200 mL of a mask removal solution (a mixture of nitric acid and cerium ammonium nitrate) for 10-30 min, and then submerging the solid material in 200 ml of water for 50-70 s, and blow-drying the solid material with nitrogen to remove the metal mask from the metasurface microstructure region to obtain the metasurface focusing lens.

In some embodiments, the optical system is a microscope optical system, a telescope optical system, a camera optical system, a projection optical system, a laser optical system, a Fourier transform optical system, a scanning optical system, or a fiber optic optical system.

In some embodiments, the optical system is a laser beam expanding optical system, a laser collimation optical system, or a laser focusing optical system.

In some embodiments of the present disclosure, the solid material such as the silicon carbide or the diamond is used to be integrated into the metasurface focusing lens with excellent refractive properties, focusing properties, and thermal conductivity, in place of the original combined solution of a focusing objective lens and an externally attached cooling structure, or an SiO₂/Si₃N₄ metalens focusing scheme. While realizing miniaturization of the optical system, it can improve the thermal drift problem caused by long time irradiation of the original high-power beam, which is conducive to reducing the focal point diameter and heating focal point offset, thereby enhancing thermal stability of the focusing optical components in the optical system.

In some embodiments of the present disclosure, by setting the sub-wavelength structure units into a gradient nanopillars configuration with the two-dimensional array arrangement to synergistically match the thermal properties of the solid material with the metasurface focusing lens structure. It can achieve beam focusing by tuning the incident light amplitude and phase, with a higher degree of design freedom, a smaller focus diameter can be achieved, and the focus diameter can be adjusted only by adjusting the count of nanopillars and the middle width of the sub-wavelength structure units.

In some embodiments of the present disclosure, by first depositing the metal mask including aluminum, silver, gold, chromium, etc. on the non-metasurface microstructure region of the solid material, and then going through the processing manner of fluorine-based gas etching, the processing difficulty and manufacturing cost of the solid material such as the silicon carbide or the diamond are reduced. A metasurface focusing lens can be obtained, with a high depth-to-width ratio of 1:5, a high foldability, a high thermal conductivity, and a good focusing effect, making it suitable for large scale production.

In some embodiments of the present disclosure, the solid material for the metasurface focusing lens is capable of being applied in visible and invisible optical systems, and in particular, it has good thermal stability for high-power beams such as UV lasers and IR lasers. The thermal drift of the focus is very small under long time irradiation, which has the advantages of miniaturization, low thermal effects, reduced manufacturing costs, and suitability for large scale applications.

The technical solutions of the present disclosure will be described in further detail below in connection with specific embodiments. It should be understood that the following embodiments are only exemplary for illustrating and explaining the present disclosure and should not be construed as a limitation on the scope of protection of the present disclosure. Any technology realized based on the foregoing of this disclosure is covered by the scope of protection intended by the present disclosure.

### EMBODIMENTS

### Embodiment 1

The present embodiment used 4H-SiC material as a solid material with a refractive index of 2.6 and a thermal conductivity of 3.7 W/cm·K.

In the structural design of metasurface focusing lens, the whole of the metasurface focusing lens of the present embodiment is composed of the solid material, which includes a light-transmitting substrate layer and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone with a slope of 0-30°, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. The developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed, and heated in a water bath for 6 h, with a temperature of the water bath of 80° C., an ultrasonic treatment was performed after the completion of the water bath, an ultrasonica time was 15 min, and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, an etching power of 500 W, and an etching rate of 0.8 nm/s, to etch the non-metasurface microstructure region of the solid material layer to a predetermined etching depth d, and to accomplish the transferring of the patterns of the metasurface microstructure region between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to obtain the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, a pulse width of 130 fs, a performance test was conducted. The test result shows that the minimum focal diameter is 1.5 μm, a heating focal offset is 0.5 μm/° C., a refractive index of the metasurface focusing lens is 2.6462@589 nm, and a thermal conductivity of the metasurface focusing lens is 490 W/cm·K.

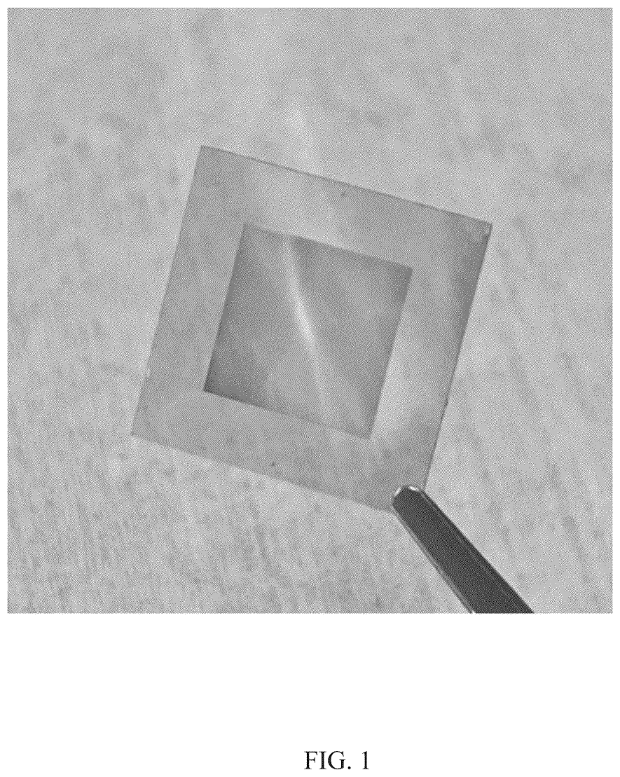

The prepared metasurface focusing lens was subjected to a macroscopic inspection, and the result is shown in FIG. 1. As shown in FIG. 1, a length and a width of the metasurface focusing lens are within a range of 1-2 cm, and a thickness of the metasurface focusing lens is not exceed 1 mm, which is conducive to the integration and miniaturization of the optical system.

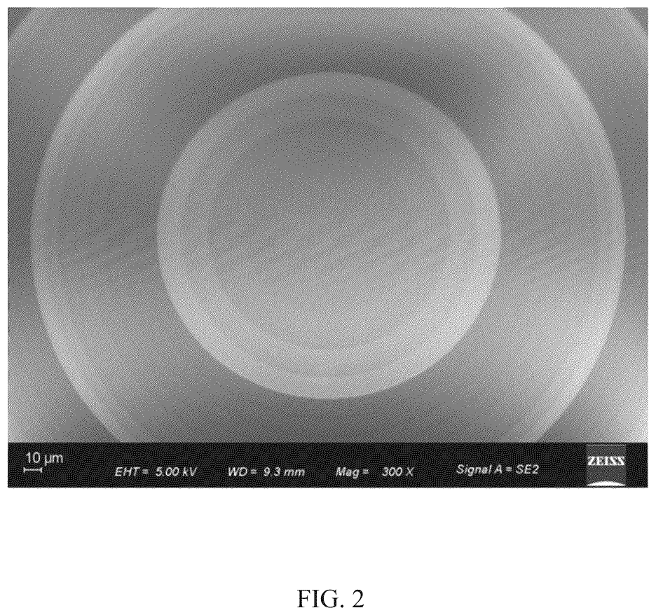

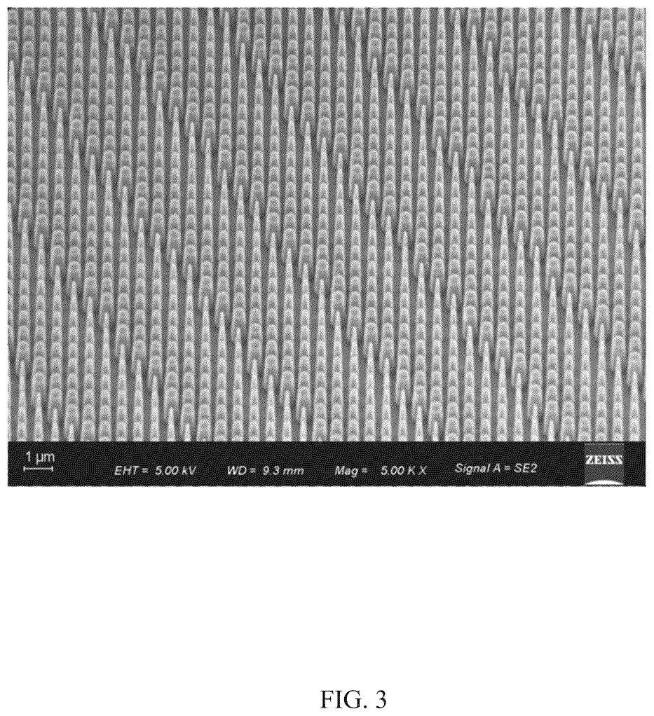

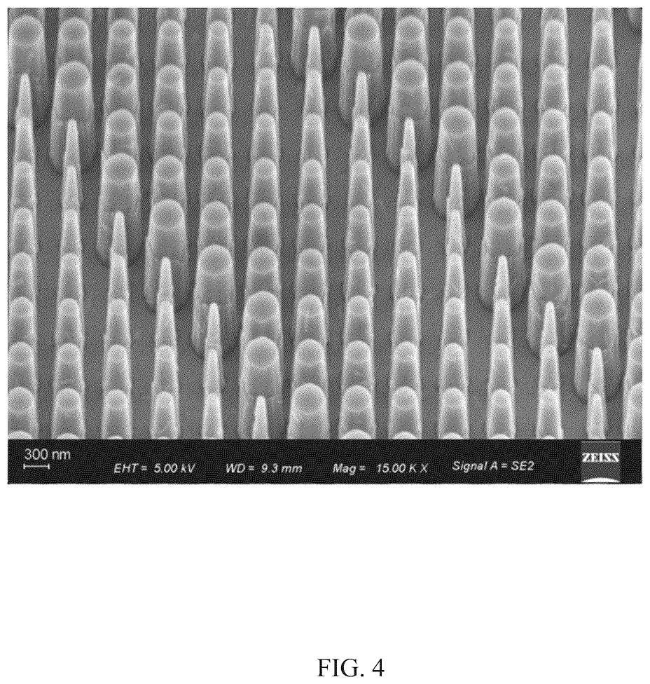

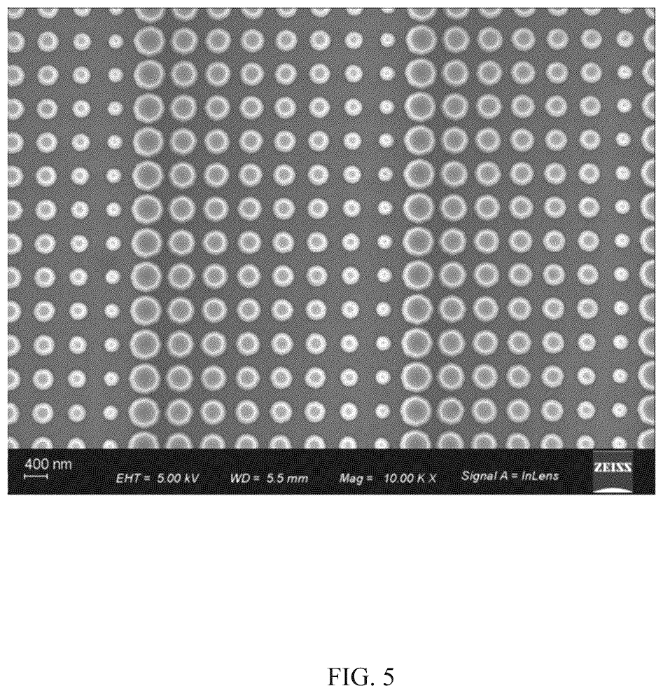

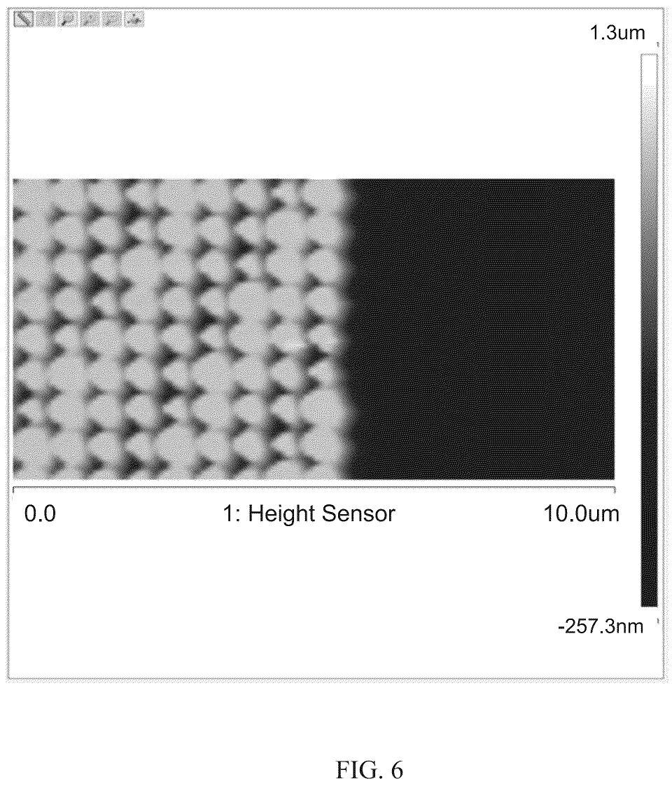

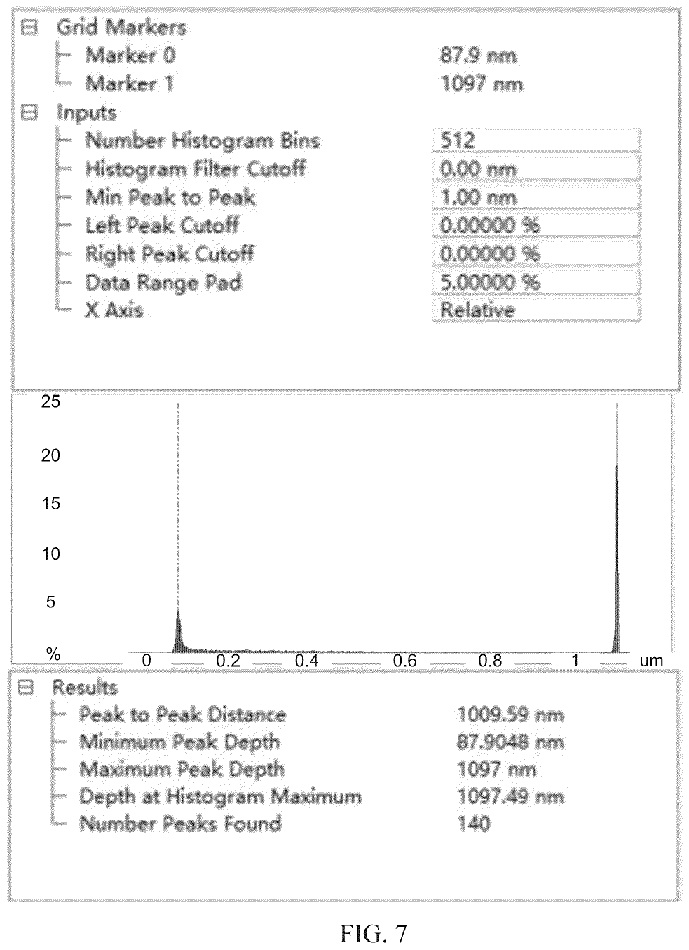

The prepared metasurface focusing lens was subjected to microscopic inspection, and the result is shown in FIGS. 2-7. As shown in FIGS. 2-7, by first depositing the metal mask composed of aluminum, silver, gold, chromium, etc., in the non-metasurface microstructure region of the solid material, and then going through the processing manner of fluorine-based gas etching, the target structure can be accurately processed with good focusing performance.

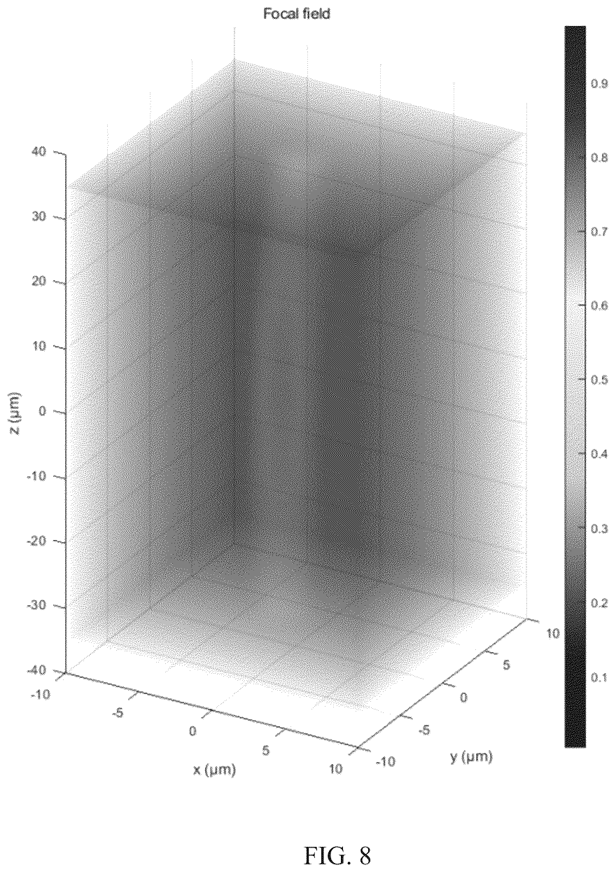

The prepared metasurface focusing lens was subjected to a focal field distribution test, and the result is shown in FIG. 8. As shown in FIG. 8, the theoretical value of the metasurface focusing lens coincides with the measured value, and the adjustment of the focal diameter can be realized only by adjusting the count of nanopillars and the middle width of the sub-wavelength structure units.

### Embodiment 2

The present embodiment preferably used 4H-SiC material as a solid material.

In the structural design of metasurface focusing lens, the whole of the metasurface focusing lens of the present embodiment is composed of the solid material, which includes a light-transmitting substrate layer and a metasurface microstructure layer disposed on the light-transmitting substrate layer. The metasurface microstructure layer includes a plurality of sub-wavelength structure units arranged in a first direction and a second direction, each of the sub-wavelength structure units includes six nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 800 nm, and a middle width w of the nanopillars is sequentially 210, 260, 290, 310, 370, and 440 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. The developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, the reaction gas was oxygen, a gas flow rate was 80 sccm, a power was 300 W, and a reaction time was 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, an etching power was 500 W, and an etching rate was 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and the solid material was blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that a minimum focal diameter is 2.5 μm and a heating focal offset is 0.7 μm/° C.

### Embodiment 3

The present embodiment preferably used 6H-SiC material as a solid material.

In the structural design of metasurface focusing lens, the whole of the metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min, and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, and an etching power of 500 W, with an etching rate of 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 2.3 μm, a heating focus offset is 0.6 μm/° C.

### Embodiment 4

The present embodiment preferably used 3C-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes six nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 255, 285, 310, 340, and 370 nm.

A preparation method for the metasurface focusing lens using the above-described solid material included follow operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min, and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, and an etching power of 500 W, with an etching rate of 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 3.1 μm, a heating focus offset is 0.8 μm/° C.

### Embodiment 5

The present embodiment preferably used diamond material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included follow operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min, and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, and an etching power of 500 W, with an etching rate of 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 1.8 μm, a heating focus offset is 0.5 pm/° C.

### Embodiment 6

The present embodiment preferably used 4H-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 5 min, an ultrasonic frequency was 30 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 1 mL, a rotational speed of the homogenization was 2000 rpm, and a time of the homogenization was 1 min. After the homogenization, the solid material was placed on a hot plate at 100° C. and baked for 1 min, and then the solid material was exposed using an electron beam lithography (EBL) machine after the homogenization, and then the exposed solid material was submerged in 200 mL of a developer solution (Zep-N50) for 50 s. Then the developed solid material was submerged in 200 mL of isopropanol for 25 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, and an etching power of 500 W, with an etching rate of 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 1.6 μm, a heating focus offset is 0.5 μm/° C.

### Embodiment 7

The present embodiment preferably used 4H-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 15 min, an ultrasonic frequency was 50 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 6 mL, a rotational speed of the homogenization was 6000 rpm, and a time of the homogenization was 3 min. After the homogenization, the solid material was placed on a hot plate at 180° C. and baked for 3 min, and then the solid material was exposed using an electron beam lithography (EBL) machine after the homogenization, and then the exposed solid material was submerged in 200 mL of a developer solution (Zep-N50) for 70 s. Then the developed solid material was submerged in 200 mL of isopropanol for 35 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.20 nm/s to deposit a metal mask with a thickness of 50 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 6 h, with a temperature of the water bath of 80° C., an ultrasonic treatment was performed after the completion of the water bath, an ultrasonic time was 15 min, and an ultrasonic frequency was 15 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 60 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 80 sccm, a power of 300 W, and a reaction time of 15 min, followed by nitrogen purging;
(e) dry etching: an inductively coupled plasma etching equipment (ICP-RIE) was used to etch the solid material obtained in step (d), with the etching gas of trifluoromethane at a flow rate of 6 sccm, the etching gas of sulfur hexafluoride at a flow rate of 18 sccm, and the etching gas of oxygen at a flow rate of 6 sccm, and an etching power of 500 W, with an etching rate of 0.8 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 20 min, then the solid material was submerged in 200 mL of water for 60 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 1.6 μm, a heating focus offset is 0.5 μm/° C.

### Embodiment 8

The present embodiment preferably used 4H-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included follow operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.01 nm/s to deposit a metal mask with a thickness of 5 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 1 h, with a temperature of the water bath of 60° C., an ultrasonic treatment was performed after the completion of the water bath, an ultrasonic time was 5 min, and an ultrasonic frequency was 10 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 50 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 70 sccm, a power of 250 W, and a reaction time of 5 min, followed by nitrogen purging;
(e) dry etching: an inductively coupled plasma etching equipment (ICP-RIE) was used to etch the solid material obtained in step (d), with the etching gas of trifluoromethane at a flow rate of 4 sccm, the etching gas of sulfur hexafluoride at a flow rate of 15 sccm, and the etching gas of oxygen at a flow rate of 4 sccm, and an etching power of 400 W, with an etching rate of 0.1 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 10 min, then the solid material was submerged in 200 mL of water for 50 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 2.1 μm, a heating focus offset is 0.6 μm/° C.

### Embodiment 9

The present embodiment preferably used 4H-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included following operations:
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.10 nm/s to deposit a metal mask with a thickness of 75 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 5 h, with a temperature of the water bath of 75° C., an ultrasonic treatment was performed after the completion of the water bath, an ultrasonic time was 10 min, and an ultrasonic frequency was 18 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 65 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 85 sccm, a power of 280 W, and a reaction time of 10 min, followed by nitrogen purging;
(e) dry etching: an inductively coupled plasma etching equipment (ICP-RIE) was used to etch the solid material obtained in step (d), with the etching gas of trifluoromethane at a flow rate of 7 sccm, the etching gas of sulfur hexafluoride at a flow rate of 16 sccm, and the etching gas of oxygen at a flow rate of 5 sccm, and an etching power of 550 W, with an etching rate of 0.5 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 15 min, then the solid material was submerged in 200 mL of water for 55 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 1.9 μm, a heating focus offset is 0.5 μm/° C.

### Embodiment 10

The present embodiment preferably used 4H-SiC material as a solid material.

In the structural design of metasurface focusing lens, the whole of metasurface focusing lens of the present embodiment is composed of the solid material, which includes a light-transmitting substrate layer, and a metasurface microstructure layer disposed on the light-transmitting substrate layer. The metasurface microstructure layer includes a plurality of sub-wavelength structure units arranged in a first direction and a second direction, each of the sub-wavelength structure units includes eight nanopillars arranged in a straight line along the first direction with a decreasing width, and an angle between the first direction and the second direction is 90°. In the sub-wavelength structure units, these nanopillars are circular truncated cone, an etching depth d of the nanopillars is 1000 nm, a period p between two adjacent nanopillars is 600 nm, and a middle width w of the nanopillars is sequentially 200, 240, 280, 310, 340, 370, 410, and 450 nm.

A preparation method for the metasurface focusing lens using the above-described solid material included follow operations.
(a) pretreatment: the solid material was first cleaned by ultrasonic cleaning with acetone, ethanol, and isopropanol in sequence, an ultrasonic time was 10 min, an ultrasonic frequency was 40 kHz, and then the solid material was blow-dried with nitrogen to remove organic matter and inorganic matter remaining on a surface of the solid material;
(b) photolithography: the cleaned solid material obtained in step (a) was first placed in the center of a carrier plate of a homogenizer, and a photoresist (Zep520A) was dripped for homogenization, an amount of dripping was 4 mL, a rotational speed of the homogenization was 4000 rpm, and a time of the homogenization was 2 min. After the homogenization, the solid material was placed on a hot plate at 150° C. and baked for 2 min, and then the solid material was exposed using an electron beam lithography (EBL) machine after the homogenization, and then the exposed solid material was submerged in 200 mL of a developer solution (Zep-N50) for 60 s. Then the developed solid material was submerged in 200 mL of isopropanol for 30 s, and the solid material was blow-dried with nitrogen to realize patterning of the metasurface microstructure region on the surface of the solid material layer;
(c) thin film deposition: an electron beam evaporation equipment was used to uniformly deposit aluminum, silver, gold, and chromium sequentially on the surface of the solid material obtained in step (b) at a deposition rate of 0.80 nm/s to deposit a metal mask with a thickness of 100 nm on the surface of the solid material layer;
(d) metal lift-off: the solid material obtained in step (c) was first submerged in 200 mL stripping solution (N-methylpyrrolidone) with the metal mask facing upwards, sealed and heated in a water bath for 12 h, with a temperature of the water bath of 100° C., an ultrasonic treatment was performed after the completion of the water bath, an ultrasonic time was 20 min, and an ultrasonic frequency was 20 kHz. Then a disposable dropper was used to bubble in the stripping solution to blow the metal mask fragments suspended in the stripping solution and the metal mask in the non-metasurface microstructure region of the solid material away from the metasurface microstructure region, and then the solid material was submerged in 200 mL of isopropanol for 70 s, rinsed the solid material with the isopropanol, and blow-dried with nitrogen to remove the metal mask in the non-metasurface microstructure region, and then the stripped solid material was placed into a plasma cleaner, with the reaction gas of oxygen at a gas flow rate of 90 sccm, a power of 350 W, and a reaction time of 20 min, followed by nitrogen purging;
(e) dry etching: an inductively coupled plasma etching equipment (ICP-RIE) was used to etch the solid material obtained in step (d), with the etching gas of trifluoromethane at a flow rate of 8 sccm, the etching gas of sulfur hexafluoride at a flow rate of 20 sccm, and the etching gas of oxygen at a flow rate of 8 sccm, and an etching power of 600 W, with an etching rate of 1 nm/s, to etch the non-metasurface microstructure region of the solid material layer to a predetermined etching depth d and to accomplish the transferring of the patterns of the metasurface microstructure between the metal mask and the solid material; and
(f) wet etching: the solid material obtained in step (e) was first submerged in 200 mL of a mask removal solution (a mixture of nitric acid and cerium ammonium nitrate) for 30 min, then the solid material was submerged in 200 mL of water for 70 s, and blow-dried with nitrogen to remove the metal mask from the metasurface microstructure region to the metasurface focusing lens.

Finally, the prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that the minimum focal diameter is 1.7 μm, a heating focus offset is 0.6 μm/° C.

### Comparative Embodiment 1

The difference from Embodiment 1 is that this embodiment preferably adopted Si₃N₄ material as the solid material.

The prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that a minimum focal diameter is 5.7 μm and a heating focus offset is 1.8 μm/° C.

### Comparative Embodiment 2

The difference from Embodiment 1 is that this embodiment preferably adopted SiO₂ material as the solid material.

The prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that a minimum focal diameter is 6.8 μm and a heating focus offset is 2.4 μm/° C.

### Comparative Embodiment 3

The difference from Embodiment 1 is that in the structural design of the metasurface focusing lens, the metasurface microstructure layer includes a plurality of sub-wavelength structure units arranged in a first direction and a second direction, each of the sub-wavelength structure units includes eight nanopillars arranged in a straight line along the first direction with a middle width of 280 nm, and an angle between the first direction and the second direction is 90°.

The prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that a minimum focal diameter is 4.5 μm and a heating focus offset is 1.5 μm/° C.

### Comparative Embodiment 4

The difference from Embodiment 1 is that steps (c-d) and (f) were not included in the process for preparing the metasurface focusing lens.

The prepared metasurface focusing lens was installed on the laser focusing optical system between a laser and a processed sample, and after being irradiated for 10 min under a focusing condition of a laser wavelength of 1064 nm, a laser power of 10 W, and a pulse width of 130 fs, a performance test was conducted. The test result shows that a minimum focal diameter is 3.7 μm and a heating focus offset is 1.2 μm/° C.

Finally, the above embodiments are only used to illustrate the technical solutions of the present disclosure and are not intended to be limiting, and although the disclosure has been described in detail with reference to the preferred embodiments, a person of ordinary skill in the art should understand that modifications or equivalent substitutions can be made to the technical solutions of the present disclosure without departing from the purpose and scope of the technical solutions of the present disclosure, all of which should be covered by the scope of the present disclosure. Although it is explained in detail with reference to the preferred embodiments, the person of ordinary skill in the art should understand that the technical program of the present disclosure can be modified or replaced by the equivalent without departing from the purpose and scope of the technical program of the present disclosure, which should be covered by the scope of the claims of the present disclosure.

What is claimed is:

1. A solid material for a metasurface focusing lens in an optical system, wherein the solid material comprises at least one element from group IIIA, group IVA, group VA, and group IIB of a periodic table.

2. The solid material of claim 1, wherein the solid material is a silicon carbide material or a diamond material.

3. The solid material of claim 1, wherein the metasurface focusing lens comprises a light-transmitting substrate layer and a metasurface microstructure layer disposed on the light-transmitting substrate layer, and the metasurface microstructure layer is composed of the solid material.

4. The solid material of claim 1, wherein the metasurface focusing lens comprises a light-transmitting substrate layer, a light-transmitting medium layer disposed on the light-transmitting substrate layer, and a metasurface microstructure layer disposed on the light-transmitting medium layer, and the light-transmitting medium layer is composed of the solid material.

5. The solid material of claim 1, wherein the metasurface focusing lens is composed of the solid material.

6. The solid material of claim 3, wherein the metasurface microstructure layer comprises a plurality of sub-wavelength structure units arranged in a two-dimensional array, and each of the plurality of sub-wavelength structure units comprises a plurality of nanopillars arranged in a straight line with a decreasing width.

7. The solid material of claim 6, wherein in each of the plurality of sub-wavelength structure units, an etching depth of the nanopillars is within a range of 800-1200 nm, a middle width of the nanopillars is within a range of 200-450 nm, a period between two adjacent nanopillars is within a range of 600-800 nm, and a middle width difference between the two adjacent nanopillars is within a range of 30-50 nm.

8. The solid material of claim 1, wherein the optical system is a microscope optical system, a telescope optical system, a camera optical system, a projection optical system, a laser optical system, a Fourier transform optical system, a scanning optical system, or a fiber optic optical system.

9. The solid material of claim 8, wherein the optical system is a laser beam expanding optical system, a laser collimation optical system, or a laser focusing optical system.

10. A preparation method for a metasurface focusing lens using a solid material, comprising:
(a) pretreating the solid material by organic cleaning and inorganic cleaning to remove organic matter and inorganic matter remaining on a surface of the solid material;
(b) performing a photolithography treatment on the cleaned solid material obtained in step (a) to realize patterning of a metasurface microstructure region on a surface of a solid material layer;
(c) performing a thin film deposition treatment on the solid material after the photolithography treatment obtained in step (b) to deposit a metal mask on the surface of the solid material layer;
(d) performing metal lift-off on the solid material after the thin film deposition treatment obtained in step (c) to remove the metal mask from a non-metasurface microstructure region;
(e) performing a dry etching treatment on the solid material after the metal lift-off obtained in step (d) to etch the non-metasurface microstructure region of the solid material layer to a predetermined etching depth, and accomplish transferring of patterns of the metasurface microstructure region between the metal mask and the solid material; and
(f) performing a wet etching treatment on the solid material after the dry etching treatment obtained in step (e) to remove the metal mask from the metasurface microstructure region to obtain the metasurface focusing lens.
